(19) United States
(12) Patent Application Publication
(10) Pub. No.: US 2012/0085212 A1
(43) Pub. Date: Apr. 12, 2012

(54) DEVICE FOR THE OPTICAL DETECTION OF THE SURFACE OF PLATE-SHAPED MATERIALS

(76) Inventors: Michele CANTELLA, Vigevano (IT); Matteo Mascetti, Milano (IT)

(21) Appl. No.: 13/268,221

(22) Filed: Oct. 7, 2011

(30) Foreign Application Priority Data
Oct. 8, 2010 (IT) MI2010U000306

(51) Int. Cl. B26D 5/00

(52) U.S. Cl. 83/365

(57) ABSTRACT

A device for the optical detection of the surface of plate-shaped materials (16) to be cut, especially suitable for continuous cutting machines or tables (10) including, at the top of a base (12), a cutting table (14) with a quadrangular square whereon said material to be cut is spread, through one or more cutting heads or units (20) carried by at least one beam (18) guided in sliding along one or more tracks (24) parallel or orthogonal to the long sides of the cutting table (14), characterised in that said device has at least one scanner (22) attached to said beam (18) or to a mobile support (28) parallel thereto.

### I. BACKGROUND OF THE INVENTION

A. Field of Invention

The present invention relates to a device for the optical detection of the surface of plate-shaped materials to be cut. More particularly, the present invention relates to a device as defined above, especially suitable for being used on continuous cutting machines or tables that make cuttings according to predetermined shapes of plate-shaped materials such as leather, hide, synthetic materials; such cuttings may be carried out using any technique, for example with blades, laser or the so-called water-jet system.

B. Related Prior Art

It is known that specific machine tools are used, provided with suitable cutting means, for making leather products and footwear, as well as different items that require cutting plate-shaped or laminar materials, including fabrics. A common type of these machines comprises a working surface or table whereon the material to be cut is laid, and one or more cutting units or heads. The cutting units or heads are connected to an arm which extends transversally above the working table and is moved in sliding along a longitudinal direction.

The material to be cut is usually stabilised on the working table by air vacuum. Such material, which especially in the case of leather and hide, defines an irregular shape, is intended to be cut in multiple zones or according to various configurations in order to obtain a plurality of semi-finished products therefrom with which, for example, uppers or parts of footwear and leather goods are made. In this type of process, the aim is to optimize the use of the material, avoiding parts to be rejected as much as possible. Such parts may derive not only from the presence of imperfections or visible defects on the material to be cut, but also from the shaping of the same material and of the semi-finished products obtained therefrom. In order to reduce such waste or scrap, optical devices are currently used, connected to a processor of the data detected that allows in the first place detecting the outline or perimeter of the material and evaluating the best location of the multiple shapes to optimise the spaces available.

This occurs according to two alternative procedures, after the optical device has detected even the most visible imperfections or defects present on the material. A first procedure envisages that, following data processing, the shapes required by the process and the optimal location thereof are projected on the material so that the operator can set the cuts in the most convenient manner. A more advanced procedure envisages the so-called nesting to be performed automatically and that the various parts of material are progressively obtained by the action of the cutting units or head/s present on the machine. The optical devices used in these operations consist of linear digital cameras or scanning means. Solutions are known wherein said scanning means or scanners are arranged on a fixed lattice above the cutting table constituting the surface wherealong the material to be cut is laid. In these cases, the lattice is positioned at a considerable height relative to the cutting table, generally not less than 1200 mm.

However, this arrangement involves some drawbacks regarding the limited precision as to the detection of possible defects present on the material due to the distance between the latter and the scanning means. Moreover, due to such distance, the detection may be altered by light effects or reflections that are created between cutting table and scanning means. A further drawback is due to the same presence of the lattice, which implies an increase of the overall production costs of the machine and determines the need for an extension of the working surface in order to create suitable zones for the support and fixing of the vertical supports thereof.

The object of the present invention is to obviate the drawbacks mentioned hereinabove. More specifically, the object of the present invention is to provide a device for the optical detection of the surface of plate-shaped materials to be cut suitable for detecting with extreme accuracy the imperfections and defects present on the material, without alterations due to light or to possible reflections that occur between the same device and the working surface.

A further object of the invention is to provide an optical detection device the positioning whereof on the continuous cutting machine or table does not require the setup of a support or lattice placed on top of the working surface whereon the material is laid.

A further object of the invention is to provide a device as defined above which consequently avoids the need of increasing the surface of the working surface for forming support zones for the vertical supports of said lattice.

A further object of the invention is to provide the users with a device for the optical detection of the surfaces of plate-shaped materials to be cut suitable for ensuring a high level of reliability during the same detection, also such as to allow obtaining an apparatus that is easy and inexpensive to be made.

### II. SUMMARY OF THE INVENTION

These and further objects are achieved by the device for the optical detection of the surface of plate-shaped materials to be cut of the present invention, which is especially suitable for continuous cutting machines or tables comprising, at the top of a base, a cutting table with a quadrangular square whereon said material to be cut is laid, through one or more cutting heads or units carried by at least one beam guided in sliding along one or more tracks parallel or orthogonal to the long sides of the cutting table and which is essentially characterised in that it comprises at least one scanner attached to said beam or to a mobile support parallel thereto.

The construction and functional features of the device of the present invention shall be better understood from the following detailed description, wherein reference is made to the annexed drawing tables showing an advantageous embodiment thereof, wherein:

### III. DESCRIPTION OF THE DRAWINGS

FIG. 1 schematically shows a top perspective view of a continuous cutting machine or table provided with the optical detection device of the present invention which is associated with the support of the cutting heads;

FIG. 2 schematically shows a top perspective view of the same cutting machine or table wherein said optical detection device is by way of an example shown released from the support of the cutting head.

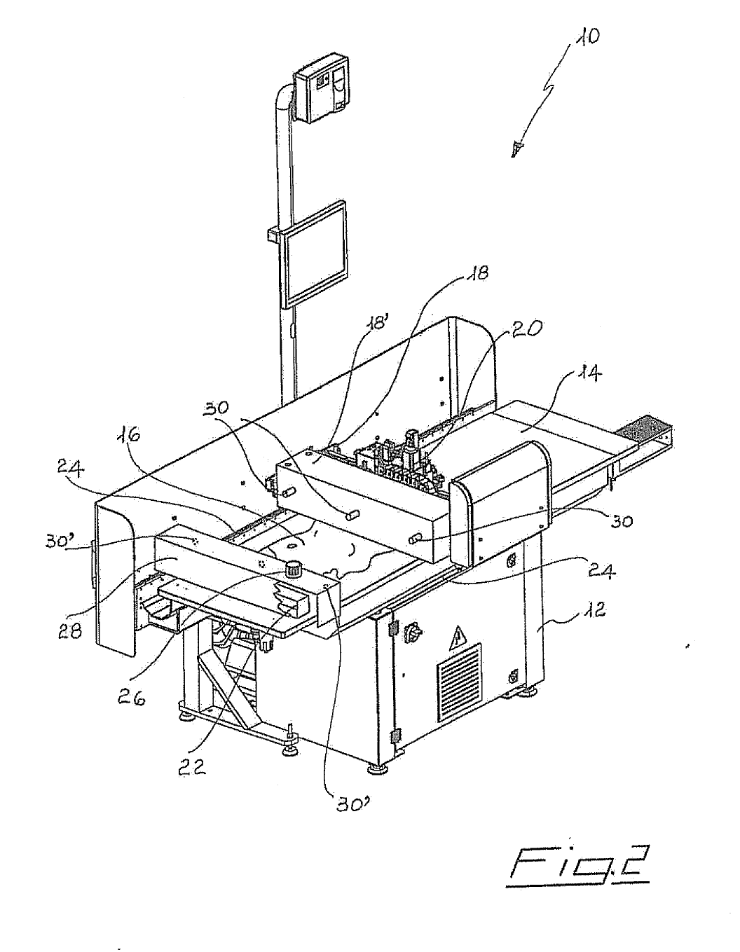

### IV. DETAILED DESCRIPTION OF THE PREFERRED EMBODIMENTS

With reference to the above figures, the device for the optical detection of plate-shaped materials to be cut of the present invention is advantageously but not critically applied to a continuous cutting machine or table globally indicated with reference numeral 10; said cutting table comprises a base 12 at the top whereof a square table 14 with planar development that forms the working surface extends. The material to be cut, schematised with reference numeral 16 and by way of an example consisting of leather having an irregular external profile or edge, is arranged on said table 14. Table 14 is shaped as a rectangle, wherein opposite longer sides define the longitudinal development and a beam 18 is made to slide parallel thereto, extended in crosswise direction, that is, preferably parallel to the opposite shorter sides of the same rectangular table 14. Beam 18 supports at least one cutting unit 20, guided and moved in a known manner along a track that extends along the beam itself.

A cutting table having the basic features mentioned above is described, for example, in application PCT/EP 2010/000311 by the applicant ATOM Spa.

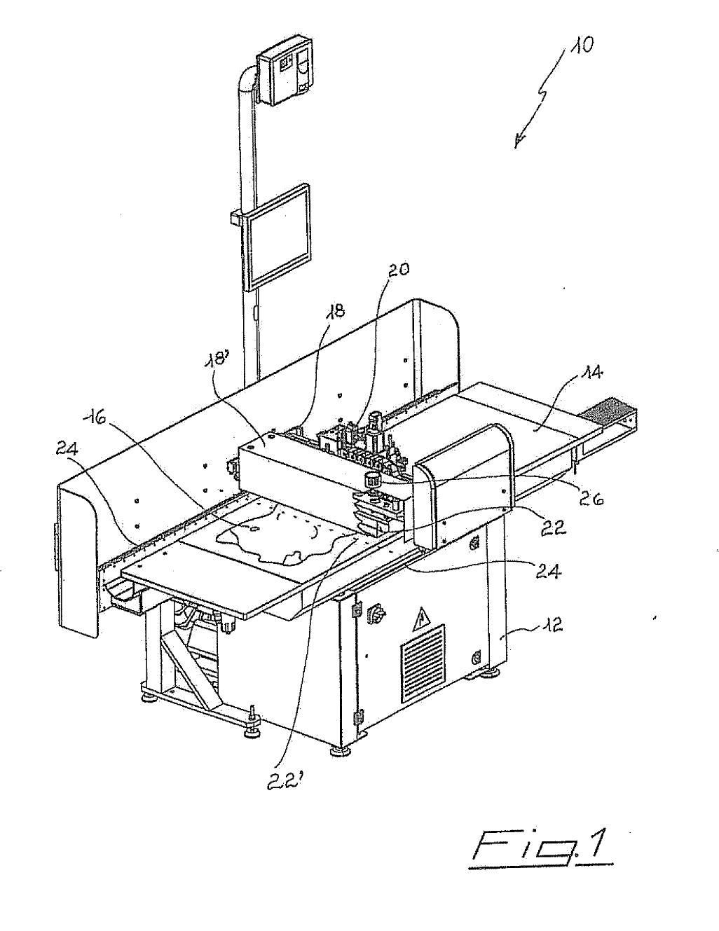

According to the invention, said cutting table is provided with the optical detection device of the present invention, consisting of one or more digital cameras, scanners or equivalent means, positioned adjacent to table 14, consequently close to material 16 lying thereon. The digital camera/s, scanners or equivalent are advantageously fixed to beam 18 carrying the cutting head or heads 20 or to an adjacent support cooperating with said beam during the optical detection step of the surface of material 16 to be cut. According to the preferred embodiment illustrated in the figures, the optical detection device combined with the cutting machine or table 10 consists of at least one scanner 22 which extends transversally to the working surface defined by table 14 and parallel to beam 18 that carries the cutting head or heads 20; the scanning line is indicated by reference numeral 22′ in FIG. 1. Advantageously, said at least one scanner 22 is integrated into a support box 18′ which partly delimits the same beam 18. More advantageously, scanner 22 is of the so-called CIS (Contact Image Sensors) type, wherein the detection sensor is substantially placed in direct contact with the object to be scanned. A scanner of this type, provided with software specifically dedicated to the detection of imperfections or defects on hides, leather and synthetic materials, is known on the market by the name Camoga Detect, marketed by the Italian company Camoga Spa. Scanner 22 is preferably sized so as to cover the entire development in height of table 14, having an extension at least equal to that of the shorter sides of the table itself. However, the possibility of using two or more combined scanners 22 of the same type is not to be excluded, placed in alignment with each other, to cover the same extension in tables 14 of special width. The possibility that a single scanner 22 is movably arranged in the support box 18′ to make progressive scans of material 16 may also be considered. As an alternative, in place of a scanner of the CIS type, the use of an ultrasound scanner may be envisaged, suitable in particular for detecting differences in depth of the surface of material 16.

Since beam 18 carrying the cutting unit or units moves along tracks 24 parallel to the longer sides of table 14, the detection made by scanner 22, whether done in a single step or swipe or in two or more steps, develops in the same direction since said scanner is constrained to said beam. According to a preferred solution, scanner 22 is arranged so that the detection sensor or sensors it is provided with are positioned at a distance comprised between 2.0 and 20.0 mm relative to material 16 lying on table 14, depending on the position with which the precise focusing of the scanner itself is obtained. In any case, such distance may be adjusted, by known means such as flywheels or knobs 26 that lift or lower scanner 22, according to the type of material 16 and, in particular, to the surface roughness thereof. The same or similar means may be arranged for the accurate focussing of the detection sensors of scanners 22 relative to material 16.

To prevent scanner 22 from being moved continuously, that is, during the operational steps that make beam 18 move to bring the cutting unit 20 in suitable positions for the cuttings, it is envisaged that the same scanner 22 may be released from beam 18 and be instead connected thereto only in the preliminary step of the optical detection of the surface of material 16 and the profile thereof. To this end, a support 28 equivalent to that consisting of box 18′ is guided, for example, along at least one of tracks 24 and may be moved outside the cutting area defined by table 14.

Such movement may be performed manually or by any suitable means. At least one scanner 22 is integrated in support 28, in the same way as the scanners integrated in box 18′.

Preferably, box 18′ is provided, on the side facing support 28, with means suitable for abutting and temporarily engaging the same support, which is then carried in shifting by the movement of beam 18 box 18′ is fixed to. Said temporary engagement means provided on box 18′ for example consist of pneumatic pistons 30, suitable for coupling with the stem thereof into complementary seats 30′ made on support 28. In this way, scanner 22 is only moved when required and is not affected by the stresses transmitted to beam 28 of the cutting unit 20 during the cutting steps of material 16.

As can be noticed from the above, the advantages achieved by the invention are clear.

The optical detection device of the present invention is in optimal conditions for carrying out an accurate and precise control on material 16, since it is placed in the proximity of the material itself and therefore also protected from alterations due to light or light reflections.

In addition, the placement of that device, advantageously comprises at least one type of scanner 22 of the so-called CIS type, at or near the beam 18 carrying the cutting units or 20, does not involve the preparation of complex and expensive supports for the same scanner.

Even the optional separation relative to beam 18 with the use of a support 28 parallel thereto and still arranged adjacent to table 14 does not result in significant construction difficulties, nor in a substantial increase in the overall production costs.

While the invention has been described with particular reference to an embodiment thereof, made by way of a non-limiting example, several changes and variations will appear clearly to a man skilled in the art in the light of the above description.

The present invention therefore is intended to include any changes and variations thereof falling within the spirit and the scope of protection of the following claims.

We claim:

1. A device for the optical detection of the surface of plate-shaped materials (16) to be cut, especially suitable for continuous cutting machines or tables (10) including, at the top of a base (12), a cutting table (14) with a quadrangular square whereon said material to be cut is spread, through one or more cutting heads or units (20) carried by at least one beam (18) guided in sliding along one or more tracks (24) parallel or orthogonal to the long sides of the cutting table (14), characterised in that said device has at least one scanner (22) attached to said beam (18) or to a mobile support (28) parallel thereto.

2. The device according to claim 1, characterised in that the scanner/s (22) are integrated into a box-type support (18′) which partly delimits the beam (18).

3. The device according to claim 1, characterised in that said scanner/s (22) is/are of the type named CIS, Contact Image Sensors and extends parallel to the short sides of the cutting table (14).

4. The device according to claim 1, characterised in that said scanner/s (22) is/are of the ultrasound type.

5. The device according to claim 3, characterised in that the detection sensor or sensors of said scanner/s (22) surmounts the material (16) laid on the cutting table at a height comprised between 2.0 and 20.0 mm.

6. The device according to claim 1, characterised in that said scanner/s (22) is/are integrated into said mobile support (28), guided in sliding along at least one of the tracks (24) wherealong the beam (18) is moved.

7. The device according to claim 5, characterised in that the mobile support (28) consists of a box movable outside the cutting area, provided on the side facing the box (18′) with temporary receipt and engagement seats (30′) carried by the box (18′).

8. The device according to claim 1, characterised in that said device comprises one or more flywheels or knobs for adjusting the height of said scanner/s (22) and/or focusing the relative sensors.

9. The device according to claim 2, characterised in that said scanner/s (22) integrated in the box (18) and in the support (28) are movable according to a direction parallel to the short sides of the cutting table (14).

10. The device according to claim 3, characterized in that said scanner/s (22) is/are of the ultrasound type.

11. The device according to claim 5, characterized in that said scanner/s (22) integrated in the box (18) and in the support (28) are movable according to a direction parallel to the short sides of the cutting table (14).
